(19) United States
(12) Patent Application Publication
(10) Pub. No.: US 2024/0305419 A1
(43) Pub. Date: Sep. 12, 2024

(54) TRANSPORT BLOCK SIZE DETERMINATION AND CODE BLOCK SEGMENTATION FOR MULTI-SLOT TRANSPORT BLOCK TRANSMISSION

(71) Applicant: Telefonaktiebolaget LM Ericsson (publ), Stockholm (SE)

(72) Inventors: Ling SU, Beijing (CN); Zhipeng LIN, Nanjing Jiangsu (CN); Yuande TAN, Beijing (CN); Robert Mark HARRISON, Grapevine, TX (US)

(21) Appl. No.: 18/261,388

(22) PCT Filed: Jan. 14, 2022
(86) PCT No.: PCT/SE2022/050040

§ 371 Date: Jul. 13, 2023

(30) Foreign Application Priority Data
Jan. 15, 2021 (WO) PCT/CN2021/072290

(51) Int. Cl. H04L 5/00; H04L 1/00; H04L 27/26

(52) U.S. Cl. CPC H04L 5/0046; H04L 1/0057; H04L 27/261

(57) ABSTRACT

The present disclosure is related to a method and communication device for transport block size determination for a multi-slot transport block transmission and a method and communication device for code block segmentation for a multi-slot transport block transmission. The method for determining a size of a multi-slot transport block (TB) for a multi-slot TB-based transmission includes: determining a number of resource elements (REs) for the transmission; determining a number of information bits at least partially based on one or more of the determined number of REs, a modulation order for the transmission, a target coding rate for the transmission, and a number of layers for the transmission; and determining the size of the multi-slot TB for the transmission at least partially based on the determined number of information bits.

### TECHNICAL FIELD

The present disclosure is related to the field of telecommunication, and in particular, to a method and communication device for transport block size determination for a multi-slot transport block transmission and a method and communication device for code block segmentation for a multi-slot transport block transmission.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels a 5G communications system is able to manage the data transfers in an orderly fashion and the system is able to understand what data is arriving and hence it is able to process it in the required fashion. As there are many different types of data that need to be transferred-user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: is the multiplexing of the logical data to be transported by the physical layer and its channels over the radio interface.
Physical channel: The physical channels are those which are closest to the actual transmission of the data over the radio access network/5G radio frequency (RF) signal. They are used to carry the data over the radio interface.

The physical channels often have higher level channels mapped onto them to provide a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a user equipment (UE) and a base station (BS, or gNB in the context of 5G NR).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method for determining a size of a multi-slot transport block (TB) for a multi-slot TB-based transmission is provided. The method comprises: determining a number of resource elements (REs) for the transmission; determining a number of information bits at least partially based on one or more of the determined number of REs, a modulation order for the transmission, a target coding rate for the transmission, and a number of layers for the transmission; and determining the size of the multi-slot TB for the transmission at least partially based on the determined number of information bits.

In some embodiments, each of the multiple slots of the multi-slot TB has an independent Demodulation Reference Signal (DM-RS) configuration. In some embodiments, each of the multiple slots of the multi-slot TB has an independent number of uplink symbols and/or an independent number of downlink symbols. In some embodiments, the multiple slots of the multi-slot TB have a same modulation and coding scheme (MCS) index, a same number of layers, and/or a same number of physical resource blocks (PRBs). In some embodiments, the step of determining a number of resource elements (REs) for the transmission comprises: calculating the number of REs for the transmission at least partially based on one or more of a number of PRBs allocated for the transmission, the number of slots for the transmission, and a number of REs allocated for each PRB in each of the slots for the transmission.

In some embodiments, the step of calculating the number of REs for the transmission comprises: calculating the number of REs for the transmission according to following equations:

$${N}_{RE} = {\sum }_{k = 1}^{{n}_{slot}} {N}_{RE}^{k}$$

$${N}_{RE}^{k} = min ( 156 , {N}_{RE}^{′ k} ) * {n}_{PRB}$$

where N_{RE} is the number of REs for the transmission, N_{RE}^{k} is the number of RES allocated in a slot k for the transmission, n_{PRB} is the number of PRBs allocated for the transmission, nₛₗₒₜ is the number of slots for the transmission, N′_{RE}^{k} is the number of REs allocated for each PRB in the slot k for the transmission.

In some embodiments, in a case where no DMRS symbol is configured in at least one slot, the step of calculating the number of REs for the transmission comprises: calculating the number of REs for the transmission according to following equations:

$${N}_{RE} = {\sum }_{k = 1}^{{n}_{slot}} {N}_{RE}^{k}$$

$$\{ \begin{matrix}{N}_{RE}^{k} = {N}_{RE}^{′ k} * {n}_{PRB} & if no DMRS symbol is configured in slot k \\ {N}_{RE}^{k} = min ( 1 \; 56 , {N}_{RE}^{′ k} ) * {n}_{PRB} & otherwise\end{matrix}$$

where N_{RE} is the number of REs for the transmission, N_{RE}^{k} is the number of RES allocated in a slot k for the transmission, n_{PRB} is the number of PRBs allocated for the transmission, nₛₗₒₜ is the number of slots for the transmission, N′_{RE}^{k} is the number of REs allocated for each PRB in the slot k for the transmission.

In some embodiments, in a case where the multiple slots for the transmission have a same number of REs, the step of calculating the number of REs for the transmission comprises: calculating the number of REs for the transmission according to the following equation:

$${N}_{RE} = min ( 156 * {n}_{slot} , {N}_{RE}^{′} ) * {n}_{PRB}$$

where N_{RE} is the number of REs for the transmission, n_{PRB} is the number of PRBs allocated for the transmission, nₛₗₒₜ is the number of slots for the transmission, and N_{RE}′ is the number of REs in all slots per PRB.

In some embodiments, in a case where all the slots have a same number of RES, the step of calculating the number of REs for the transmission comprises: calculating the number of REs for the transmission according to the following equation:

$${N}_{RE} = min ( 156 , {N}_{RE}^{″} ) * {n}_{PRB} * {n}_{slot}$$

where N_{RE} is the number of REs for the transmission, n_{PRB} is the number of PRBs allocated for the transmission, nₛₗₒₜ is the number of slots for the transmission, and N_{RE}″ is the number of REs in each slot per PRB.

In some embodiments, the step of determining a number of information bits comprises: calculating the number of information bits according to the following equation:

$${N}_{info} = {N}_{RE} * R * {Q}_{m} * v$$

where N_{info} is the number of information bits, N_{RE} is the number of REs for the transmission, Qₘ is the modulation order for the transmission, R is the target coding rate for the transmission, and ν is the number of layers for the transmission.

In some embodiments, the step of determining the size of the multi-slot TB for the transmission at least partially based on the determined number of information bits comprises: comparing the determined number of information bits for the transmission with a threshold value; and determining the size of the multi-slot TB by using a pre-determined lookup table based on the determined number of information bits in response to determining that the determined number of information bits being less than or equal to the threshold value.

In some embodiments, the step of determining the size of the multi-slot TB by using a pre-determined lookup table based on the determined number of information bits comprises: determining an intermediate number of information bits based on the determined number of information bits, and using the pre-determined lookup table to determine the size of the multi-slot TB based on the intermediate number of information bits.

In some embodiments, the step of determining the size of the multi-slot TB by using a pre-determined lookup table based on the determined number of information bits comprises: quantizing intermediate number of information bits

$${N}_{info}^{′} = max ( 24 , {2}^{n} \cdot ⌊ \frac{{N}_{info}}{{2}^{n}} ⌋ ) ,$$

where n=max(3,└ log₂(N_{inf o})┘−6), and using the pre-determined lookup table to find the closest size of the multi-slot TB that is not less than N_{inf o}′.

In some embodiments, the step of determining the size of the multi-slot TB for the transmission at least partially based on the determined number of information bits comprises: comparing the determined number of information bits for the transmission with a threshold value; and determining the size of the multi-slot TB according to a pre-determined equation in response to determining that the determined number of information bits being greater than the threshold value. In some embodiments, the threshold value is 3824 or 8424.

In some embodiments, after the step of determining the size of the multi-slot TB for the transmission at least partially based on the determined number of information bits, the method further comprises: comparing the determined size of the multi-slot TB with a maximum TB size; and adjusting the size of the multi-slot TB to be equal to the maximum TB size in response to determining that the determined size of the multi-slot TB being greater than the maximum TB size; and determining the size of the multi-slot TB as it is in response to determining that the determined size of the multi-slot TB being less than or equal to the maximum TB size. In some embodiments, the maximum TB size for the transmission is either predetermined or received via Radio Resource Control (RRC) or Downlink Control Information (DCI) signaling.

In some embodiments, after the step of determining the size of the multi-slot TB for the transmission at least partially based on the determined number of information bits, the method further comprises: comparing the determined size of the multi-slot TB with a maximum TB size which is not pre-configured but calculated at least partially based on a maximum number of slots in a multi-slot TB; and determining the size of the multi-slot TB as the maximum TB size in response to determining that the determined size of the multi-slot TB being greater than the maximum TB size; and determining the size of the multi-slot TB as it is in response to determining that the determined size of the multi-slot TB being less than or equal to the maximum TB size.

In some embodiments, the maximum number of slots in a multi-slot TB is either predetermined or received via Radio Resource Control (RRC) or Downlink Control Information (DCI) signaling. In some embodiments, the method is performed by a user equipment. In some embodiments, the transmission is a physical uplink shared channel (PUSCH) transmission.

According to a second aspect of the present disclosure, a communication device comprising: a processor; a memory storing instructions which, when executed by the processor, cause the processor to perform any of the methods of the first aspect.

According to a third aspect of the present disclosure, a method for segmenting a multi-slot transport block (TB) into code blocks (CB) is provided. The method comprises: determining whether segmentation of the multi-slot TB into CBs is to be performed or not at least partially based on at least one of following parameters:—whether the multi-slot TB is to be transmitted based on TB or based on CB group (CBG), —a size of the multi-slot TB, —a number of slots of the multi-slot TB, and—a time duration of the multi-slot TB, and segmenting the multi-slot TB into CBs in response to determining that the segmentation of the multi-slot TB into CBs is to be performed.

In some embodiments, the method further comprises: calculating and adding a cyclic redundancy check (CRC) to the multi-slot TB before segmenting the multi-slot TB into CBs. In some embodiments, the method further comprises: calculating and adding a CRC to each of the CBs after segmenting the multi-slot TB into CBs. In some embodiments, each of the CBs spans one or more slots. In some embodiments, the number of slots which are spanned by a CB group (CBG) comprising one or more CGs segmented from the multi-slot TB is determined as follows:

$$n = ⌊ \frac{K}{N} ⌋$$

$$or$$

$$n = ⌈ \frac{K}{N} ⌉$$

where n is the number of slots which are spanned by a CBG, K is the number of slots which are spanned by the multi-slot TB, N is the number of CBGs in the multi-slot TB, └·┘ is the floor function, and ┌·┐ is the ceiling function.

In some embodiments, all the CBGs of the multi-slot TB except for the last CBG have a same number of slots. In some embodiments, the step of determining whether segmentation of the multi-slot TB into CBs is to be performed or not comprises: determining whether segmentation of the multi-slot TB into CBs is to be performed or not based on one or more of parameters comprising an indicator of whether the multi-slot TB is to be transmitted based on TB or based on CBG, a number of CBs in the multi-slot TB, a number of CBGs in the multi-slot TB, and a number of CBs in a CBG. In some embodiments, one or more of the parameters are received via RRC or DCI signaling. In some embodiments, one or more of the parameters are predefined. In some embodiments, the number of CBs in a CBG is 1. In some embodiments, all CBGs of the multi-slot TB except for the last CBG have the number of CBs in CBG calculated as follows:

$$⌊ \frac{number of CBs in the multislot TB}{number of CBGs in the multislot TB} ⌋$$

$$or$$

$$⌈ \frac{number of CBs in the multislot TB}{number of CBGs in the multislot TB} ⌉$$

where └·┘ is the floor function, and ┌·┐ is the ceiling function.

In some embodiments, the number of CBG in the multi-slot TB is determined at least partially based on one or more of: a number of slots in the multi-slot TB; a size of the multi-slot TB; and a time duration from the first slot to the last slot in the multi-slot TB. In some embodiments, the method further comprises: transmitting all CBGs of the multi-slot TB in the initial transmission. In some embodiments, the method further comprises: receiving an indication of failed transmission of one or more CBGs of the multi-slot TB; and retransmitting the indicated CBGs of the multi-slot TB.

In some embodiments, the method further comprises: receiving an indication of redundancy version (RV) for the multi-slot TB via RRC or DCI signaling. In some embodiments, the method further comprises: determining a single RV for all information bits of the multi-slot TB. In some embodiments, the method further comprises: determining an independent RV for each of CBGs of the multi-slot TB. In some embodiments, the method further comprises: determining an independent RV for each of CBs of the multi-slot TB. In some embodiments, the method further comprises: keeping the multi-slot TB as it is in response to determining that the segmentation of the multi-slot TB into CBs is not to be performed. In some embodiments, the method is performed by a user equipment. In some embodiments, the multi-slot TB is a part of a physical uplink shared channel (PUSCH).

According to a fourth aspect of the present disclosure, a communication device is provided. The communication device comprises: a processor; a memory storing instructions which, when executed by the processor, cause the processor to perform any of the methods of the third aspect.

According to a fifth aspect of the present disclosure, a computer program comprising instructions is provided. The instructions, when executed by at least one processor, cause the at least one processor to carry out the method of the first aspect and/or the third aspect.

According to a sixth aspect of the present disclosure, a carrier containing the computer program of the fifth aspect, wherein the carrier is one of an electronic signal, optical signal, radio signal, or computer readable storage medium.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is an overview diagram illustrating an exemplary 5G NR PUSCH transport process in which enhancement for multi-slot transport block (TB) according to an embodiment of the present disclosure is applicable.

FIG. 2 is a diagram illustrating an exemplary code block (CB) segmentation procedure for a single-slot TB.

FIG. 3 is a diagram illustrating an exemplary CB segmentation for a multi-slot TB according to an embodiment of the present disclosure.

FIG. 4 is a flow chart illustrating an exemplary method for TB size determination for a multi-slot TB based transmission according to an embodiment of the present disclosure.

FIG. 5 is a flow chart illustrating an exemplary method for CB segmentation for a multi-slot TB according to an embodiment of the present disclosure.

FIG. 6 schematically shows an embodiment of an arrangement which may be used in a communication device according to an embodiment of the present disclosure.

FIG. 7 is a block diagram of an exemplary communication device according to an embodiment of the present disclosure.

FIG. 8 is a block diagram of an exemplary communication device according to another embodiment of the present disclosure.

FIG. 9 schematically illustrates a telecommunication network connected via an intermediate network to a host computer.

FIG. 10 is a generalized block diagram of a host computer communicating via a base station with a user equipment over a partially wireless connection.

FIG. 11 to FIG. 14 are flowcharts illustrating methods implemented in a communication system including a host computer, a base station and a user equipment.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (NR), the present disclosure is not limited thereto. In fact, as long as TBS determination and/or CB segmentation are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5th Generation New Radio (5G NR), etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, or any other equivalents. Further, please note that the term “indicator” used herein may refer to an indication, an attribute, a setting, a configuration, a profile, an identifier, a field, one or more bits/octets, or any data by which information of interest may be indicated directly or indirectly.

Further, although some embodiments of the present disclosure are described with reference to PUSCH, the present disclosure is not limited thereto. For example, the inventive concept introduced in the embodiments may also applicable to PDSCH. In fact, the inventive concept introduced in the embodiments may also applicable to any radio access technology involving a multi-slot transport block with some appropriate modifications/alterations/substitutions known to those skilled in the art from the teaching of the present disclosure.

Further, following 3GPP documents are incorporated herein by reference in their entireties:
3GPP TS 38.211 V16.3.0 (2020-09), 3rd Generation Partnership Project; Technical Specification Group Radio Access Network; NR; Physical channels and modulation (Release 16);
3GPP TS 38.212 V16.3.0 (2020-09), 3rd Generation Partnership Project; Technical Specification Group Radio Access Network; NR; Multiplexing and channel coding (Release 16);
3GPP TS 38.213 V16.3.0 (2020-09), 3rd Generation Partnership Project; Technical Specification Group Radio Access Network; NR; Physical layer procedures for control (Release 16);
3GPP TS 38.214 V16.3.0 (2020-09), 3rd Generation Partnership Project; Technical Specification Group Radio Access Network; NR; Physical layer procedures for data (Release 16);
3GPP TS 38.321 V16.2.1 (2020-09), 3rd Generation Partnership Project; Technical Specification Group Radio Access Network; NR; Medium Access Control (MAC) protocol specification (Release 16); and
3GPP TS 38.331 V16.2.0 (2020-09), 3rd Generation Partnership Project; Technical Specification Group Radio Access Network; NR; Radio Resource Control (RRC) protocol specification (Release 16).

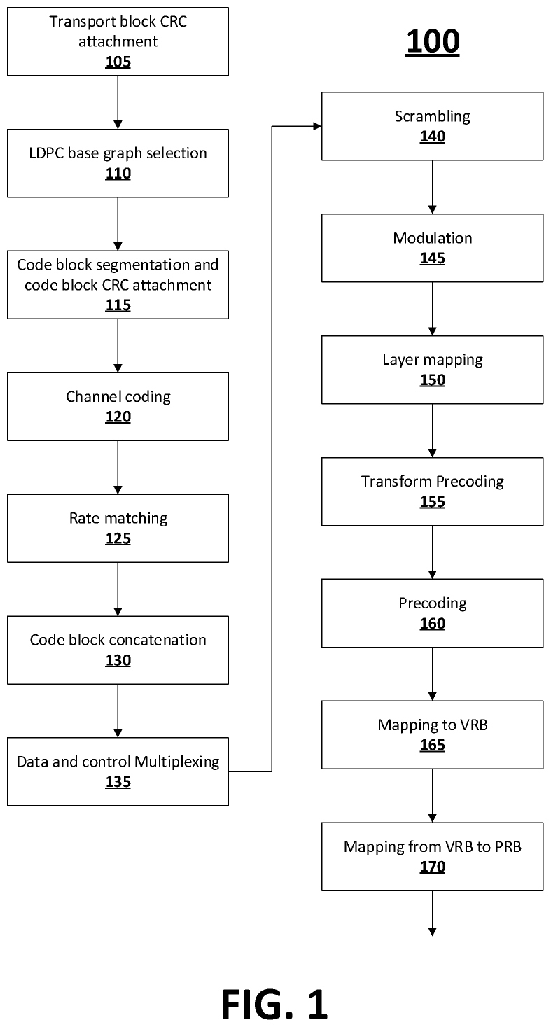

FIG. 1 is an overview diagram illustrating an exemplary 5G NR PUSCH transport process 100 in which enhancement for multi-slot transport block (TB) according to an embodiment of the present disclosure is applicable. The overall procedure of the process 100 is listed as below:
(105) Transport block CRC attachment;
(110) LDPC base graph selection;
(115) Code block segmentation and code block CRC Attachment;
(120) Channel coding;
(125) Rate matching;
(130) Code block concatenation;
(135) Data and control multiplexing;
(140) Scrambling;
(145) Modulation;
(150) Layer mapping;
(155) Transform precoding;
(160) Precoding;
(165) Mapping to VRB; and
(170) Mapping from VRB to PRB.

Step 105: Error detection is provided on each UL-SCH transport block through a Cyclic Redundancy Check (CRC). The entire transport block is used to calculate the CRC parity bits, and the parity bits are computed and attached to the UL-SCH transport block.

Step 110: For initial transmission of a transport block with coding rate R indicated by the MCS index and subsequent re-transmission of the same transport block, each code block of the transport block is encoded with either LDPC base graph 1 or 2.

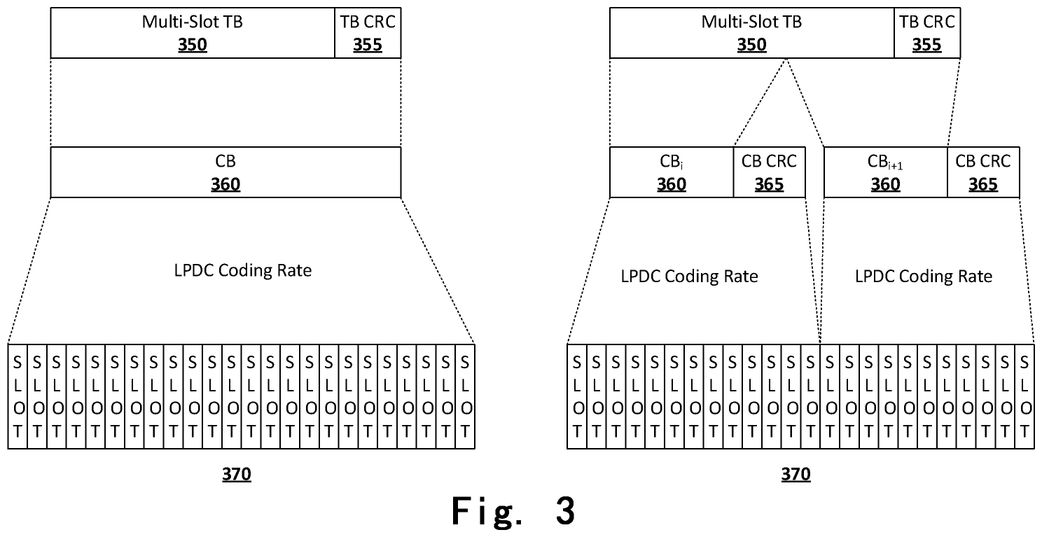

Step 115: The bits input to this step are the bits in the transport block including its CRC. Code block segmentation and code block CRC attachment may be performed, which will be described in details with reference to FIG. 3.

Step 120: Code blocks are delivered to this step. Each code block is individually LDPC encoded.

Step 125: Coded bits for each code block are delivered to this step. Each code block is individually rate matched by setting I_{LBRM}=1 if higher layer parameter rateMatching is set to limitedBufferRM and by setting I_{LBRM}=0 otherwise.

Step 130: The input bit sequence for this step are the sequences generated from step 125. Code block concatenation is performed to generate concatenated coded bits.

Step 135: The coded bits for data and control (e.g. HARQ-ACK, CG-UCI, CSI) will be multiplexed in this step to generate a multiplexed data and control coded bit sequence.

Step 140: For the single codeword, the block of bits shall be scrambled by an RNTI of a specific type (e.g., C-RNTI, MCS-C-RNTI, SP-CSI-RNTI, CS-RNTI, RA-RNTI) prior to modulation, resulting in a block of scrambled bits.

Step 145: For the single codeword, the block of scrambled bits shall be modulated using one of the modulation schemes in the following Table 1, resulting in a block of complex-valued modulation symbols.

TABLE 1
Supported modulation schemes.

| | |
|---|---|
| Transform precoding disabled | Transform precoding enabled |

| Modulation | Modulation | Modulation | Modulation |
|---|---|---|---|
| scheme | order Qₘ | scheme | order Qₘ |
| | | π/2-BPSK | 1 |
| QPSK | 2 | QPSK | 2 |
| 16QAM | 4 | 16QAM | 4 |
| 64QAM | 6 | 64QAM | 6 |
| 256QAM | 8 | 256QAM | 8 |

Step 150: For the single codeword, the complex-valued modulation symbols for the codeword to be transmitted shall be mapped onto up to four layers according to a table defined in 3GPP TS 38.211 v16.3.0. Complex-valued modulation symbols d^{(q)}(0), . . . , d^{(q)}(M_{symb}^{(q)}−1 for codeword q shall be mapped onto the layers x(i)=[x⁽⁰⁾(i) . . . x^{(ν-1)}(i)]^{T}, i=0, 1, . . . , M_{symb}^{layer}−1 where ν is the number of layers and M_{symb}^{layer} is the number of modulation symbols per layer.

Step 155: This is to convert the PUSCH data into the form of DFT-s-OFDM (a kind of SC-FDMA as in LTE PUSCH) to spread UL data in a special way to reduce PAPR (peak to average ratio) of the waveform, depending on multiple factors, such as, configuration of phase-tracking reference signals, the number of layers, etc.

Step 160: A matrix called Precoding matrix is multiplied to the data from the previous step. Typically, the precoding matrix may be determined by two different methods: codebook and non-codebook based. In codebook based method, the matrix is determined by the information specified in DCI and some additional configurations in RRC message. In Non-codebook based method, the precoding matrix may be determined by the measurement result of NZP-CSI-RS resource.

Step 165: For each of the antenna ports used for transmission of the PUSCH, the block of complex-valued symbols shall be multiplied with the amplitude scaling factor in order to conform to the transmit power specified in TS 38.213 and mapped to resource elements in the virtual resource blocks assigned for transmission which meet all of the following criteria:
they are in the virtual resource blocks assigned for transmission, and
the corresponding resource elements in the corresponding physical resource blocks are not used for transmission of the associated DM-RS, PT-RS, or DM-RS intended for other co-scheduled UEs.

Step 170: Virtual resource blocks shall be mapped to physical resource blocks according to non-interleaved mapping.

Before describing the details of TBS determination and CB segmentation for the multi-slot TB, some related information will be introduced below.

### PUSCH Repetition in NR Rel-15 and Rel-16

### NR Rel-15

Slot aggregation for PUSCH is supported in Rel-15 and renamed to PUSCH Repetition Type A in Rel-16. The name PUSCH repetition Type A is used even if there is only a single repetition, i.e. no slot aggregation. In Rel. 15, a PUSCH transmission that overlaps with DL symbols is not transmitted.

For DCI granted multi-slot transmission (PDSCH/PUSCH) vs. semi-static DL/UL assignment:
If semi-static DL/UL assignment configuration of a slot has no direction confliction with scheduled PDSCH/PUSCH assigned symbols, the PDSCH/PUSCH in that slot is received/transmitted.
If semi-static DL/UL assignment configuration of a slot has direction confliction with scheduled PDSCH/PUSCH assigned symbols, the PDSCH/PUSCH transmission in that slot is not received/transmitted, i.e. the effective number of repetitions reduces.

In Rel. 15, the number of repetitions is semi-statically configured by RRC parameter pusch-AggregationFactor. At most 8 repetitions are supported.
pusch-AggregationFactor ENUMERATED {n2, n4, n8}

Early termination of PUSCH repetitions was discussed in R14 NR SI in RAN1 #88 with below agreement, but not standardized finally.

R1-1703868 WF on grant-free repetitions Huawei, HiSilicon, Nokia, ABS, ZTE, ZTE Microelectronics, CATT, Convida Wireless, CATR, OPPO, Inter Digital, Fujitsu Agreements:
For UE configured with K repetitions for a TB transmission with/without grant, the UE can continue repetitions (FFS can be different RV versions, FFS different MCS) for the TB until one of the following conditions is met
   If an UL grant is successfully received for a slot/mini-slot for the same TB
   FFS: How to determine the grant is for the same TB
   FFS: An acknowledgement/indication of successful receiving of that TB from gNB
   The number of repetitions for that TB reaches K
   FFS: Whether it is possible to determine if the grant is for the same TB
   Note that this does not assume that UL grant is scheduled based on the slot whereas grant free allocation is based on mini-slot (vice versa)
   Note that other termination condition of repetition may apply

This document is incorporated herein by reference in its entirety.

### NR Rel-16

A new repetition format PUSCH repetition Type B is supported in Rel-16, which PUSCH repetition allows back-to-back repetition of PUSCH transmissions. The biggest difference between the two types is that repetition Type A only allows a single repetition in each slot, with each repetition occupying the same symbols. Using this format with a PUSCH length shorter than 14 introduces gaps between repetitions, increasing the overall latency. The other change compared to Rel. 15 is how the number of repetitions is signalled. In Rel. 15, the number of repetitions is semi-statically configured, while in Rel. 16 the number of repetitions can be indicated dynamically in DCI. This applies both to dynamic grants and configured grants type 2.

In NR R16, invalid symbols for PUSCH repetition Type B include reserved UL resources. The invalid symbol pattern indicator field is configured in the scheduling DCI. Segmentation occurs around symbols that are indicated as DL by the semi-static TDD pattern and invalid symbols.

Below shows the signalling of number of repetitions.

From 3GPP TS 38.214 V16.2.0:

For PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetitions K is determined as
if numberofrepetitions is present in the resource allocation table, the number of repetitions K is equal to numberofrepetitions;
else if the UE is configured with pusch-AggregationFactor, the number of repetitions K is equal to pusch-AggregationFactor;
otherwise K=1.

Format DCI0_1 in 38.212 V16.1.0:

Time domain resource assignment-0, 1, 2, 3, 4, 5, or 6 bits
If the higher layer parameter PUSCH-TimeDomainResourceAllocationList-ForDCIformat0_1 is not configured and if the higher layer parameter pusch-TimeDomainAllocationList is configured, 0, 1, 2, 3, or 4 bits as defined in Clause 6.1.2.1 of [6, TS38.214]. The bitwidth for this field is determined as ┌log₂(I)┐ bits, where I is the number of entries in the higher layer parameter pusch-TimeDomainAllocationList or pusch-TimeDomainAllocationList-r16;
If the higher layer parameter PUSCH-TimeDomainResourceAllocationList-ForDCIformat0_1 is configured, 0, 1, 2, 3, 4, 5 or 6 bits as defined in Clause 6.1.2.1 of [6, TS38.214]. The bitwidth for this field is determined as ┌log₂(I)┐ bits, where I is the number of entries in the higher layer parameter PUSCH-TimeDomainResourceAllocationList-ForDCIformat0_1;
otherwise the bitwidth for this field is determined as ┌log₂(I)┐ bits, where I is the number of entries in the default table.

From 38.331 V16.1.0

PUSCH-Config information element

| | |
|---|---|
| pusch-TimeDomainAllocationList | SetupRelease { PUSCH- |

TimeDomainResourceAllocationList }

| | |
|---|---|
| pusch-AggregationFactor | ENUMERATED { n2, n4, n8 } |

OPTIONAL, -- Need S
pusch-TimeDomainAllocationListForDCI-Format0-1-r16 SetupRelease { PUSCH-
TimeDomainResourceAllocationList-r16 }
pusch-TimeDomainAllocationListForDCI-Format0-2-r16 SetupRelease { PUSCH-
TimeDomainResourceAllocationList-r16 }

PUSCH-TimeDomainResourceAllocation information element
-- ASN1START
-- TAG-PUSCH-TIMEDOMAINRESOURCEALLOCATIONLIST-START

| | |
|---|---|
| PUSCH-TimeDomainResourceAllocationList ::= | SEQUENCE (SIZE(1..maxNrofUL- |

Allocations)) OF PUSCH-TimeDomainResourceAllocation

| | |
|---|---|
| PUSCH-TimeDomainResourceAllocation ::= | SEQUENCE { |

| | |
|---|---|
| k2 | INTEGER(0..32) |

OPTIONAL, -- Need S

| | |
|---|---|
| mappingType | ENUMERATED {typeA, typeB}, |
| startSymbolAndLength | INTEGER (0..127) |

}

| | |
|---|---|
| PUSCH-TimeDomainResourceAllocationList-r16 ::= | SEQUENCE (SIZE(1..maxNrofUL- |

Allocations-r16)) OF PUSCH-TimeDomainResourceAllocation-r16

| | |
|---|---|
| PUSCH-TimeDomainResourceAllocation-r16 ::= | SEQUENCE { |

| | |
|---|---|
| k2-r16 | INTEGER(0..32) |

OPTIONAL, -- Need S

| | |
|---|---|
| puschAllocationList-r16 | SEQUENCE |

(SIZE(1..maxNrofMultiplePUSCHs-r16)) OF PUSCH-Allocation-r16,
...
}
PUSCH-Allocation-r16 ::= SEQUENCE {

| | |
|---|---|
| mappingType-r16 | ENUMERATED {typeA, typeB} |

OPTIONAL, -- Cond NotFormat01-02-Or-TypeA

| | |
|---|---|
| startSymbolAndLength-r16 | INTEGER (0..127) |

OPTIONAL, -- Cond NotFormat01-02-Or-TypeA

| | |
|---|---|
| startSymbol-r16 | INTEGER (0..13) |

OPTIONAL, -- Cond RepTypeB

| | |
|---|---|
| length-r16 | INTEGER (1..14) |

OPTIONAL, -- Cond RepTypeB

| | |
|---|---|
| numberOfRepetitions-r16 | ENUMERATED {n1, n2, n3, n4, n7, |

n8, n12, n16} OPTIONAL, -- Cond Format01-02
...
}
-- TAG-PUSCH-TIMEDOMAINRESOURCEALLOCATIONLIST-STOP
-- ASN1STOP

| | | |
|---|---|---|
| maxNrofUL-Allocations | INTEGER ::= 16 | -- Maximum number |

of PUSCH time domain resource allocations.

| | | |
|---|---|---|
| maxNrofUL-Allocations-r16 | INTEGER ::= 64 | -- Maximum number |

of PUSCH time domain resource allocations

### Code Blocks

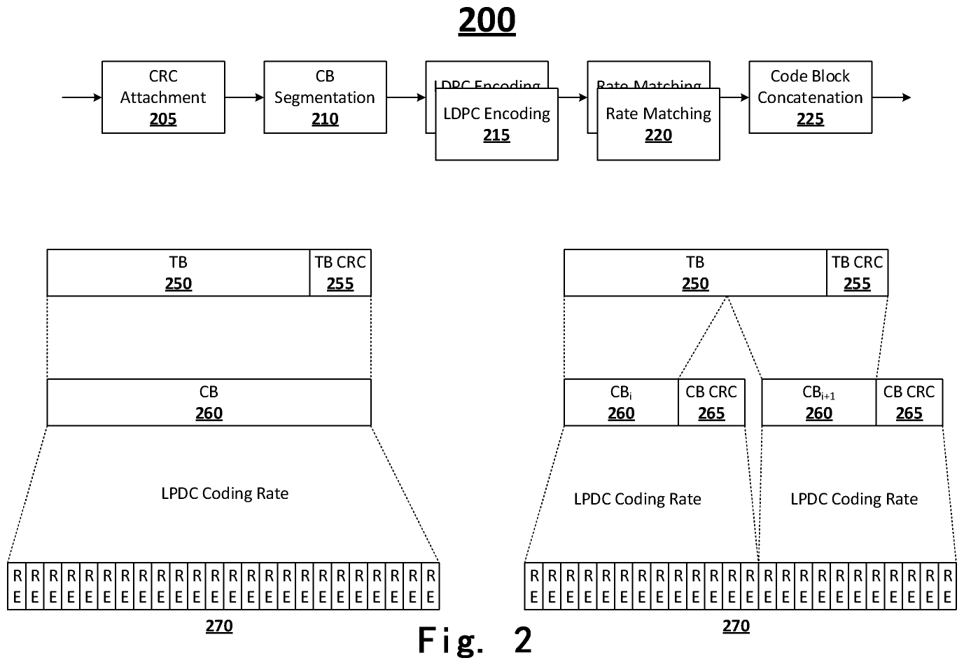

FIG. 2 is a diagram illustrating an exemplary code block (CB) segmentation procedure 200 for a single-slot TB. As can be seen from FIG. 1 and FIG. 2, the steps 205, 210, 215, 220, and 225 correspond to the steps 105, 115, 120, 125, and 130, respectively.

At step 205, a CRC 255 is appended to a TB 250, and at step 210, the TB 250 with the CRC 255 may be segmented into CBs 260 depending on one or more factors, such as the size of the TB, and a CB-level CRC 265 for each of the segmented CBs 260 may be appended, as shown in the bottom right portion of FIG. 2. Further, if the TB 250 with the CRC 255 is not segmented, then no CB-level CRC 265 is needed, as shown in the bottom left portion of FIG. 2.

At step 215, each of the code blocks is individually LDPC encoded.

At step 220, each code block is individually rate matched by setting I_{LBRM}=1 if higher layer parameter rateMatching is set to limitedBufferRM and by setting I_{LBRM}=0 otherwise.

At step 225, the input bit sequence for this step are the sequences generated from step 220. Code block concatenation is performed to generate concatenated coded bits.

In NR R15, CBG-based PUSCH/PDSCH transmission may be used to avoid sending the correctly decoded data in retransmission. The N_{info}′ needs to be greater than 3792 bits to have multiple CBS.
Set number of code blocks

$$C = \{ \begin{matrix}1 & if {N}_{info}^{′} + 24 \leq {K}_{s} \\ ⌈ \frac{{N}_{info}^{′} + 24}{{K}_{s} - 24} ⌉ & otherwise\end{matrix}$$

where Kₛ=3840 if code rate

$$R \leq \frac{1}{4} ;$$

otherwise, Kₛ=8448.

In 38.214 v16.3.0

### UE Procedure for Grouping of Code Blocks to Code Block Groups

If a UE is configured to transmit code block group (CBG) based transmissions by receiving the higher layer parameter codeBlockGroupTransmission in PUSCH-ServingCellConfig, the UE shall determine the number of CBGs for a PUSCH transmission as

M=min(N,C)

where N is the maximum number of CBGs per transport block as configured by maxCodeBlockGroupsPerTransportBlock in PUSCH-ServingCellConfig, and C is the number of code blocks in the PUSCH according to the procedure defined in Clause 6.2.3 of TS 38.212.

Define

$${M}_{1} = mod ( C , M ) , {K}_{1} = ⌈ \frac{C}{M} ⌉ , and {K}_{2} = ⌊ \frac{C}{M} ⌋ .$$

If M₁>0, CBG m, m=0, 1 . . . , M₁−1, consists of code blocks with indices m·K₁+k, k=0.1, . . . , K₁−1. CBG m, m=M₁, M₁+1, . . . , M−1, consists of code blocks with indices M₁·K₁+(m−M₁)·K₂+k, k=0, 1, . . . , K₂−1.

### UE Procedure for Transmitting Code Block Group Based Transmissions

If a UE is configured to transmit code block group based transmissions by receiving the higher layer parameter codeBlockGroupTransmission in PUSCH-ServingCellConfig,
For an initial transmission of a TB as indicated by the New Data Indicator field of the scheduling DCI, the UE may expect that the CBGTI field indicates all the CBGs of the TB are to be transmitted, and the UE shall include all the code block groups of the TB.
For a retransmission of a TB as indicated by the New Data Indicator field of the scheduling DCI, the UE shall include only the CBGs indicated by the CBGTI field of the scheduling DCI.

A bit value of 0′ in the CBGTI field indicates that the corresponding CBG is not to be transmitted and 1′ indicates that it is to be transmitted. The order of CBGTI field bits is such that the CBGs are mapped in order from CBG #0 onwards starting from the MSB.

### PUSCH TBS Determination, DL TB Scaling

In 38.214 v16.3.0:

1) The UE shall first determine the number of RES (N_{RE}) within the slot:
A UE first determines the number of REs allocated for PUSCH within a PRB (N_{RE}′) by
N_{RE}′=N_{sc}^{RB}·N_{symb}^{sh}−N_{DMRS}^{PRB}−Nₒₕ^{PRB}, where N_{sc}^{RB}=12 is the number of subcarriers in the frequency domain in a physical resource block, N_{symb}^{sh}, is the number of symbols of the PUSCH allocation within the slot, N_{DMRS}^{PRB} is the number of REs for DM-RS per PRB in the allocated duration including the overhead of the DM-RS CDM groups without data, as described for PUSCH with a configured grant in Clause 6.1.2.3 or as indicated by DCI format 0_1 or as described for DCI format 0_0 in Clause 6.2.2, and Nₒₕ^{PRB} is the overhead configured by higher layer parameter xOverhead in PUSCH-ServingCellConfig. If the Nₒₕ^{PRB} is not configured (a value from 6, 12, or 18), the Nₒₕ^{PRB} is assumed to be 0. For Msg3 transmission the Nₒₕ^{PRB} is always set to 0.

1) A UE determines the total number of REs allocated for PUSCH (N_{RE}) by N_{RE}=min(156, N_{RE}′)·n_{PRB} where n_{PRB} is the total number of allocated PRBs for the UE.

2) Intermediate number of information bits (N_{info}) is obtained by N_{inf o}=N_{RE}·R·Qₘ·ν. If N_{inf o}≤3824

Use step 3 as the next step of the TBS determination

else

Use step 4 as the next step of the TBS determination

end if

3) If N_{info}≤3824, TBS is determined as follows
quantized intermediate number of information bit

$${N}_{info}^{′} = max ( 24 , {2}^{n} \cdot ⌊ \frac{{N}_{info}^{′}}{{2}^{n}} ⌋ ) ,$$

where n=max(3, └ log₂(N_{info})┘−6).
use table 2 find the closest TBS that is not less than N_{inf o}′.

TABLE 2
TBS for N_{inf o} ≤ 3824

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

4) otherwise, use a formula to determine TBS

When N_{inf o}>3824, TBS is determined as follows.
quantized intermediate number of information bits

$${N}_{info}^{′} = max ( 3840 , {2}^{n} \times round ( \frac{{N}_{info}^{′} - 24}{{2}^{n}} ) ) ,$$

where n=└ log₂(N_{inf o}−24)┘−5 and ties in the round function are broken towards the next largest integer.

$$if R \leq 1 / 4$$

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{3816} ⌉$$

$$else$$

$$if {N}_{info}^{′} > 8424$$

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{8424} ⌉$$

$$else$$

$$TBS = 8 \cdot ⌈ \frac{{N}_{info}^{′} + 24}{8} ⌉ - 24$$

$$end if$$

$$end if$$

### DL TB Scaling

For the PDSCH assigned by a PDCCH with DCI format 1_0 with CRC scrambled by P-RNTI, or RA-RNTI, MsgB-RNTI, TBS determination follows the steps 1-4 with the following modification in step 2: a scaling N_{inf o}=S·N_{RE}·R·Qₘ·ν is applied in the calculation of N_{info}, where the scaling factor is determined based on the TB scaling field in the DCI as in Table 3.

TABLE 3
Scaling factor of N_{info} for P-RNTI, RA-RNTI and MsgB-RNTI

| TB scaling field | Scaling factor S |
|---|---|
| 00 | 1 |
| 01 | 0.5 |
| 10 | 0.25 |
| 11 | |

### DMRS Positions for Intra-Slot Frequency Hopping

From 38.211 v16.0.0:

TABLE 4
PUSCH DM-RS positions l̅ within a slot for single-
symbol DM-RS and intra-slot frequency hopping enabled.

| | DM-RS positions l̅ | | | | | | | | | | | |
|---|---|---|---|---|---|---|---|---|---|---|---|---|
| | PUSCH mapping type A | | | | | | | | PUSCH mapping type B | | | |
| | l₀ = 2 | | | | l₀ = 3 | | | | l₀ = 0 | | | |
| | dmrs-AdditionalPosition | | | | dmrs-AdditionalPosition | | | | dmrs-AdditionalPosition | | | |
| | pos0 | | pos1 | | pos0 | | pos1 | | pos0 | | pos1 | |
| l_{d} in | 1^{st} | 2^{nd} | 1^{st} | 2^{nd} | 1^{st} | 2^{nd} | 1^{st} | 2^{nd} | 1^{st} | 2^{nd} | 1^{st} | 2^{nd} |
| symbols | hop | hop | hop | hop | hop | hop | hop | hop | hop | hop | hop | hop |
| ≤3 | — | — | — | — | — | — | — | — | 0 | 0 | 0 | 0 |
| 4 | 2 | 0 | 2 | 0 | 3 | 0 | 3 | 0 | 0 | 0 | 0 | 0 |
| 5, 6 | 2 | 0 | 2 | 0, 4 | 3 | 0 | 3 | 0, 4 | 0 | 0 | 0, 4 | 0, 4 |
| 7 | 2 | 0 | 2, 6 | 0, 4 | 3 | 0 | 3 | 0, 4 | 0 | 0 | 0, 4 | 0, 4 |

In NR Rel-15 and 16, TB size is determined by RE resources with a number of PRBs and a number of no more than 14 OFDM symbols, i.e. no more than a slot in time domain. To reach certain UL data rate, usually multiple PRBs in a slot are allocated for a TB transmission.

However increasing resources in frequency domain will make a lower power density of the signals transmitted on each OFDM symbol, thus making the channel estimation accuracy worse, given the limitation of the total power of UE can have. So the option to improve the performance of a PUSCH transmission is to increase resources in time domain, e.g. repetition in time domain.

Furthermore, on top of increasing time domain resource, to reduce the overhead of CRC and reduce the coding rate, the TBS of a PUSCH transmission can be determined according to multiple slots, and different versions of encoded samples can be mapped to different slots for the PUSCH transmission across the multiple slots.

To support this multi-slot TB transmission, following issues need to be addressed:
TBS determination
   TBS determination needs to consider how the e.g. DMRS, MCS are configured for different slots among the multiple slots used for this multi-slot TB transmission and that different symbol collisions on different slots due to TDD UL DL pattern.
TB segmentation into multiple CBS
   a long delay may be required to retransmit a TB over too many slots, to avoid such issue, CB segmentation for such multi-slot TB can be applied
Redundancy version determination for each slot
   Self-decodable RVs may be needed if different RVs are expected to be used for different slots.

Therefore, some embodiments of the present disclosure provide methods on TB process over multiple slots, including
TBS determination
TB segmentation into multiple CB
Redundancy version determination for each slot

Some embodiments of the present disclosure provide methods on the TB processing to support multi-slot TB transmission on PUSCH, considering both coverage and latency of the PUSCH transmissions. The methods cover solutions on TBS determination, CBG-based transmission, and the redundancy version determination.

PUSCH coverage was identified as one of coverage bottlenecks. Single transport block (TB) transmission over multiple slots was proposed as a candidate solution of coverage enhancement of PUSCH. In NR Rel-15/16, one UL TB is confined to the UL symbols in a slot. To support high data rate, multiple PRBs in a slot constitute a TB and multiple PRBs share total UE transmission power.

Some embodiments of the present disclosure provide detailed design on TB processing to support multi-slot TB which reduces code rate by reducing CRC overhead in some slots of the TB.

### TBS Determination

Similar to TB size determination for a PUSCH transmission in a normal slot, for multi-slot TB transmission, in some embodiments, the TBS can be calculated based on the number of allocated PRBs within the multiple slots with below four steps.
UE may first determine the number of RES (N_{RE}) within the time frequency resource for the multi-slot TB transmission
UE may determine Intermediate number of information bits (N_{info}) is obtained based on the number of REs, modulation order, target coding rate and number of layers.
If the number of information bits is no greater than a predetermined or configured value, use a look-up table to determine TBS; otherwise, use formulas specified in the step 4) in section 5.1.3.2 of 38.214 V16.3.0 to determine TBS.

In one embodiment, multiple slots of a TB can have different DMRS configurations and numbers of UL symbols per slot, but the same MCS index, layer number and/or number of PRB per slot.

In one embodiment, if a TB crosses multiple slots, one or more of below methods can be used for TBS determination for step 1.

In some embodiments, a UE shall first determine the number of REs across allocated PRB in each of the slots. For the slot kamong the set of nₛₗₒₜ slots in total, the number of REs may be calculated by N_{RE}^{k}=min(156, N′_{RE}^{k})*n_{PRB} in the condition that each slot at least contains one DMRS symbol. Then the total number of RES (N_{RE}) across multiple slots can be counted as N_{RE}=Σₖ₌₁ⁿ^{ₛₗₒₜ}N_{RE}^{k}, where
n_{PRB} is the number of allocated PRBs for the multi-slot TB transmission,
nₛₗₒₜ is the number of slots for the multi-slot TB transmission,
N′_{RE}^{k}, is the number of REs allocated for the multi-slot TB transmission within a PRB in a slot k,
N_{RE}^{k} is the number of REs allocated for the TB transmission on all allocated PRBs in a slot k,
N_{RE} is the total number of REs across multiple slots on all PRBs.

For multi-slot TB, if the UL symbols in a slot are to be used for new information bits, the UL symbols are counted as the number of symbols of the PUSCH allocation within the slot; otherwise for a slot with only part of scheduled L symbols are available, one method is to use the UL symbols as symbol-wise repetition of a particular slot, such that symbols in this slot don't carry new information and are not counted for TBS determination.

In some embodiments, if UE is configured with no DMRS symbols in some of the multiple slots of a TB, the number of REs may be calculated by N_{RE}^{k}=N′_{RE}^{k}*n_{PRB} in these slots, otherwise N_{RE}^{k}=min(156, N′_{RE}^{k})*n_{PRB}. Then the total number of RES (N_{RE}) across multiple slots can be counted as N_{RE}=Σₖ₌₁ⁿ^{ₛₗₒₜ}N_{RE}^{k}, where
n_{PRB} is the number of allocated PRBs for the multi-slot TB transmission,
nₛₗₒₜ is the number of slots for the multi-slot TB transmission, N′_{RE}^{k} is the number of REs allocated for the multi-slot TB transmission within a PRB in a slot k,
N_{RE}^{k} is the number of REs allocated for the TB transmission on all allocated PRBs in a slot k,
N_{RE} is the total number of REs across multiple slots on all PRBs.

In some embodiments, when the multiple slots have same number of available REs in each slot:

the total number of REs may be calculated by

$${N}_{RE} = min ( 156 * {n}_{slot} , {N}_{RE}^{′} ) * {n}_{PRB}$$

where,
n_{PRB} is the total number of allocated PRBs for the multi-slot TB transmission,
N_{RE}′ is defined as the total number of available REs in all slots per PRB,
N_{RE} is the total number of REs across multiple slots.

In some embodiments, when all slots have same number of available REs, the total number of REs on all allocated PRBs and slots for this multi-slot TB transmission may be calculated by

$${N}_{RE} = min ( 1 \; 56 , {N}_{RE}^{″} ) * {n}_{PRB} * {n}_{slot}$$

where,
n_{PRB} is the total number of allocated PRBs for the multi-slot TB transmission,
N_{RE}″ is defined as the total number of available REs in each slot per PRB,
N_{RE} is the total number of REs across multiple slots on all PRBs for the multi-slot TB transmission.

In one embodiment, a maximum TB size for multi-slot TB may be RRC/DCI configured or pre-determined. With this embodiment, the actual TB size of multi-slot TB can be between the value determined after step 4 and the maximum TB size defined.

As an example, the maximum TB size can be the maximum TB size such that only one code block is needed and no CB segmentation is needed. One detailed example can be based on the CB segmentation mechanism applied in NR release 15 and release 16, wherein if N_{inf o}≤3824, 3824 is the maximum TB size without CB segmentation, and if N_{info}>3824, 8424 is the maximum TB size without CB segmentation.

According to 38.214 v16.3.0:

When N_{inf o}≤3824, step 3 is used. The maximum TBS happens when N_{inf o}=3824. According to the formula of step 3

$${N}_{info}^{′} = max ( 24 , {2}^{n} \cdot ⌊ \frac{{N}_{info}}{{2}^{n}} ⌋ ) = 38 \; 08 ,$$

where n=max(3, └ log₂(N_{inf o})┘−6)=5. In the look-up table, the closest TBS that is not less than N_{info}′ is =3824.

When N_{inf o}>3824, step 4 is used. Quantized intermediate number of information bits

$${N}_{info}^{′} = max ( 3840 , {2}^{n} \times round ( \frac{{N}_{info}^{′} - 24}{{2}^{n}} ) ) .$$

It means N_{info}′≥3840.
If R≤¼,

$$C = ⌈ \frac{{N}_{info}^{′} + 24}{3816} ⌉ .$$

Since N_{info}′≥3840, C, the number of code blocks in the transport block, is at least two, which means CB segmentation is applied.
if R>¼,
if N_{info}′>8424,

$$C = ⌈ \frac{{N}_{info}^{′} + 24}{8424} ⌉$$

will be at least 2, which means CB segmentation is applied.
else

$$T B S = 8 \cdot ⌈ \frac{{N}_{info}^{′} + 24}{8} ⌉ - 24 .$$

In this case the maximum TBS happens when N_{info}′=8424. Therefore, maximum TBS without CB segmentation is 8424.

According to 38.212 v16.1.0, TBS=3824 is the largest TBS without CB segmentation for LDPC base graph2 and 8424 for LDPC base graph1.

In some embodiments, one multi-slot TB does not have to be split into multiple CBs which reduces complexity of this feature especially when it's deployed in the use case with a data rate not that high.

Multi-slot TB can be used for the services with low data rate and low latency requirement, rather than eMBB services. Maximum TB size can be specified. Since number of slots of the multi-slot TB is an important factor to determine the TB size, maximum number of slots can also be defined.

In another embodiment, a maximum number of slots for multi-slot TB can be RRC/DCI configured or pre-determined. With this method, the maximum TBS, if not defined, can be determined based on the maximum number of slots and other resources configured. Note that both maximum number of slots and maximum TBS are defined either in a predetermined manner or based on the configuration by network.

### Code Block Segmentation, RV

In NR Rel-15/16, PUSCH initial transmission and retransmission can be based on TB or CBG. If CBG is not configured, the granularity of transmission is TB. If a UE is configured with CBG-based transmission and N_{info}>3824, TB is segmented into multiple CB, which forms CBG. CBGTI field of the scheduling DCI indicates which CBGs are to be retransmitted. TB, CB and CBG are confined to a slot.

For multi-slot TB, CB and CBG can cross slot boundary and transmission can be based on TB or CBG. On the other hand, multi-slot TB is likely to be used for small TB size due to small number of allocated PRB. According to Rel-15/16, TBS for 1 PRB in a slot is 24 with 3˜4 DMRS or 32 with 1˜2 DMRS. A TB needs to span at least 104 slots to reach 3824, Rel-15 threshold for CB segmentation. Therefore, to facilitate CBG based multi-slot TB transmission, CB and CBG can be additionally RRC/DCI configured.

In some embodiments, TB-level CRC may be added to the multi-slot TB.

In some embodiments, for CBG-based transmission, if a multi-slot TB is segmented into multiple code blocks, CB-level CRC may be added to each CB. Each code block can be within one slot or span multiple slots. A CBG, indexed with CBGTI, may include one or multiple code blocks.

In some embodiments, if a multi-slot TB crosses K slots and is segmented into N CBG, N<=K, each CBG except the last CBG spans └_{N}/^{K}┘ or ┌_{N}/^{K}┐ slots.

As illustrated in FIG. 3, the left portion of FIG. 3 shows one TB that is across multiple slots without CB segmentation. The right portion of FIG. 3 shows a TB that is segmented into two CBs, each of which forms a CBG and maps to multiple slots.

In some embodiments, UE can be RRC/DCI configured or predefined with one or more of below parameters in order to segment TB into multiple CBs.
The multi-slot TB transmission is based on TB or CBG
number of CBs in a TB
number of CBGs in a TB
number of CB in a CBG

In some embodiments where the number of CB in a CBG is predefined, a CBG may have only one CB if not otherwise configured.

In some embodiments, one or more parameters can depend on one or more other parameters. For example number of CBs in a CBG except the last CBG may be

$$⌊ \frac{number of CBs in a TB}{number of CBGs in a TB} ⌋$$

$$or$$

$$⌈ \frac{number of CBs in a TB}{number of CBGs in a TB} ⌉ .$$

In some embodiments, number of CBGs in a TB can be determined based on one or more of:
number of slots of a TB
TB size
   E.g. a TB size threshold can be defined for determining whether a TB segmentation is needed, wherein the threshold can be a fixed value or configured by network.
Time duration from the first slot to the last slot for the TB transmission
   E.g. when a duration is too long and longer than a delay_threshold, the TB can be segmented into different CBGs so that different CBGs can be retransmitted independently instead of waiting till the last slot of the TB transmission.

In some embodiments, UE may transmit all CBGs of a TB in initial transmission; UE may transmit only CBGs that fail to be detected, e.g. those indicated by CBGTI in retransmission scheduling signalling.

Compared with TB-based retransmission, CBG-based retransmission may reduce latency and save physical resources. This is especially noticeable in multi-slot TB. If a multi-slot TB contains two CBG, gNB can decode the first CBG and triggers its retransmission without waiting for decoding of the second CBG. The scheduling of retransmission is advanced by half of all slots of a TB.

In some embodiments, redundancy version (RV) of multi-slot TB can be RRC/DCI configured or predetermined with one or more of below methods.
One RV can be applied for all information bits of a TB
If TB is segmented into CBs, different RV can be applied for different CB or CBG as long as the RV are self-decodable, including RV0 and RV3. For example, RV cycling of RV0 and RV3 is applied to multiple CBs. If RV cycling is applied to CBG, it means all CB in the CBG use the same RV.

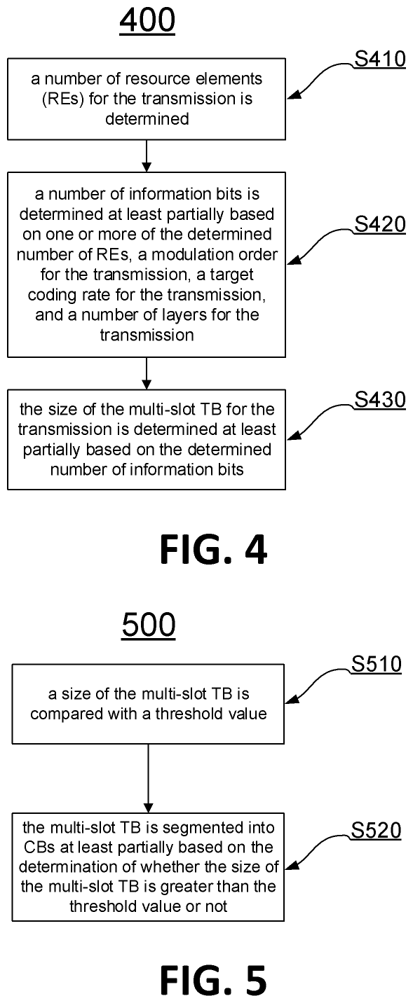

FIG. 4 is a flow chart of an exemplary method 400 for determining a size of a multi-slot transport block (TB) for a multi-slot TB-based transmission according to an embodiment of the present disclosure. The method 400 may be performed at a communication device (e.g. a UE or a gNB). The method 400 may comprise step S410, S420, and step S430. However, the present disclosure is not limited thereto. In some other embodiments, the method 400 may comprise more steps, less steps, different steps or any combination thereof. Further the steps of the method 400 may be performed in a different order than that described herein. Further, in some embodiments, a step in the method 400 may be split into multiple sub-steps and performed by different entities, and/or multiple steps in the method 400 may be combined into a single step.

The method 400 may begin at step S410 where a number of resource elements (REs) for the transmission may be determined.

At step S420, a number of information bits may be determined at least partially based on one or more of the determined number of REs, a modulation order for the transmission, a target coding rate for the transmission, and a number of layers for the transmission.

At step S430, the size of the multi-slot TB for the transmission may be determined at least partially based on the determined number of information bits.

In some embodiments, each of the multiple slots of the multi-slot TB may have an independent Demodulation Reference Signal (DM-RS) configuration. In some embodiments, each of the multiple slots of the multi-slot TB may have an independent number of uplink symbols and/or an independent number of downlink symbols. In some embodiments, the multiple slots of the multi-slot TB may have a same modulation and coding scheme (MCS) index, a same number of layers, and/or a same number of physical resource blocks (PRBs). In some embodiments, the step of determining a number of resource elements (REs) for the transmission may comprise: calculating the number of REs for the transmission at least partially based on one or more of a number of PRBs allocated for the transmission, the number of slots for the transmission, and a number of REs allocated for each PRB in each of the slots for the transmission.

In some embodiments, the step of calculating the number of REs for the transmission may comprise: calculating the number of REs for the transmission according to following equations:

$${N}_{RE} = {\sum }_{k = 1}^{{n}_{slot}} {N}_{RE}^{k}$$

$${N}_{RE}^{k} = min ( 156 , {{N}^{′}}_{RE}^{k} ) * {n}_{PRB}$$

where N_{RE} is the number of REs for the transmission, N_{RE}^{k} is the number of RES allocated in a slot k for the transmission, n_{PRB} is the number of PRBs allocated for the transmission, nₛₗₒₜ is the number of slots for the transmission, N′_{RE}^{k} is the number of REs allocated for each PRB in the slot k for the transmission.

In some embodiments, in a case where no DMRS symbol is configured in at least one slot, the step of calculating the number of REs for the transmission may comprise: calculating the number of REs for the transmission according to following equations:

$${N}_{RE} = {\sum }_{k = 1}^{{n}_{slot}} {N}_{RE}^{k}$$

$$\{ \begin{matrix}{N}_{RE}^{k} = {{N}^{′}}_{RE}^{k} * {n}_{PRB} & if no DMRS symbol is configured in slot k \\ {N}_{RE}^{k} = min ( 156 , {{N}^{′}}_{RE}^{k} ) * {n}_{PRB} & otherwise\end{matrix}$$

where N_{RE} is the number of REs for the transmission, N_{RE}^{k} is the number of RES allocated in a slot k for the transmission, n_{PRB} is the number of PRBs allocated for the transmission, nₛₗₒₜ is the number of slots for the transmission, N′_{RE}^{k} is the number of REs allocated for each PRB in the slot k for the transmission.

In some embodiments, in a case where the multiple slots for the transmission have a same number of REs, the step of calculating the number of REs for the transmission may comprise: calculating the number of REs for the transmission according to the following equation:

$${N}_{RE} = min ( 156 * {n}_{slot} , {N}_{RE}^{′} ) * {n}_{PRB}$$

where N_{RE} is the number of REs for the transmission, n_{PRB} is the number of PRBs allocated for the transmission, nₛₗₒₜ is the number of slots for the transmission, and N_{RE}′ is the number of REs in all slots per PRB.

In some embodiments, in a case where all the slots have a same number of RES, the step of calculating the number of REs for the transmission may comprise: calculating the number of REs for the transmission according to the following equation:

$${N}_{RE} = min ( 156 , {N}_{RE}^{″} ) * {n}_{PRB} * {n}_{slot}$$

where N_{RE} is the number of REs for the transmission, n_{PRB} is the number of PRBs allocated for the transmission, nₛₗₒₜ is the number of slots for the transmission, and N_{RE}″ is the number of REs in each slot per PRB.

In some embodiments, the step of determining a number of information bits may comprise: calculating the number of information bits according to the following equation:

$${N}_{info} = {N}_{RE} * R * {Q}_{m} * v$$

where N_{info} is the number of information bits, N_{RE} is the number of REs for the transmission, Qₘ is the modulation order for the transmission, R is the target coding rate for the transmission, and ν is the number of layers for the transmission.

In some embodiments, the step of determining the size of the multi-slot TB for the transmission at least partially based on the determined number of information bits may comprise: comparing the determined number of information bits for the transmission with a threshold value; and determining the size of the multi-slot TB by using a pre-determined lookup table based on the determined number of information bits in response to determining that the determined number of information bits being less than or equal to the threshold value.

In some embodiments, the step of determining the size of the multi-slot TB by using a pre-determined lookup table based on the determined number of information bits comprises: determining an intermediate number of information bits based on the determined number of information bits, and using the pre-determined lookup table to determine the size of the multi-slot TB based on the intermediate number of information bits.

In some embodiments, the step of determining the size of the multi-slot TB by using a pre-determined lookup table based on the determined number of information bits may comprise: quantizing intermediate number of information bits

$${N}_{info}^{′} = max ( 24 , {2}^{n} \cdot ⌊ \frac{{N}_{info}}{{2}^{n}} ⌋ ) ,$$

where n=max(3, └ log₂(N_{inf o})┘−6), and using the pre-determined lookup table to find the closest size of the multi-slot TB that is not less than N_{inf o}′.

In some embodiments, the step of determining the size of the multi-slot TB for the transmission at least partially based on the determined number of information bits may comprise: comparing the determined number of information bits for the transmission with a threshold value; and determining the size of the multi-slot TB according to a pre-determined equation in response to determining that the determined number of information bits being greater than the threshold value. In some embodiments, the threshold value may be 3824 or 8424.

In some embodiments, after the step of determining the size of the multi-slot TB for the transmission at least partially based on the determined number of information bits, the method may further comprise: comparing the determined size of the multi-slot TB with a maximum TB size; and adjusting the size of the multi-slot TB to be equal to the maximum TB size in response to determining that the determined size of the multi-slot TB being greater than the maximum TB size; and determining the size of the multi-slot TB as it is in response to determining that the determined size of the multi-slot TB being less than or equal to the maximum TB size. In some embodiments, the maximum TB size for the transmission may be either predetermined or received via Radio Resource Control (RRC) or Downlink Control Information (DCI) signaling.

In some embodiments, after the step of determining the size of the multi-slot TB for the transmission at least partially based on the determined number of information bits, the method may further comprise: comparing the determined size of the multi-slot TB with a maximum TB size which is not pre-configured but calculated at least partially based on a maximum number of slots in a multi-slot TB; and determining the size of the multi-slot TB as the maximum TB size in response to determining that the determined size of the multi-slot TB being greater than the maximum TB size; and determining the size of the multi-slot TB as it is in response to determining that the determined size of the multi-slot TB being less than or equal to the maximum TB size.

In some embodiments, the maximum number of slots in a multi-slot TB may be either predetermined or received via Radio Resource Control (RRC) or Downlink Control Information (DCI) signaling. In some embodiments, the method 400 may be performed by a user equipment. In some embodiments, the transmission may be a physical uplink shared channel (PUSCH) transmission.

FIG. 5 is a flow chart of an exemplary method 500 for segmenting a multi-slot transport block (TB) into code blocks (CB) according to an embodiment of the present disclosure. The method 500 may be performed at a communication device (e.g. a UE or a gNB). The method 500 may comprise step S510 and step S520. However, the present disclosure is not limited thereto. In some other embodiments, the method 500 may comprise more steps, less steps, different steps or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510, where whether segmentation of the multi-slot TB into CBs is to be performed or not may be determined at least partially based on at least one of following parameters:
whether the multi-slot TB is to be transmitted based on TB or based on CB group (CBG),
a size of the multi-slot TB,
a number of slots of the multi-slot TB, and
a time duration of the multi-slot TB.

At step S520, the multi-slot TB may be segmented into CBs in response to determining that the segmentation of the multi-slot TB into CBs is to be performed.

In some embodiments, the method 500 may further comprise: calculating and adding a cyclic redundancy check (CRC) to the multi-slot TB before segmenting the multi-slot TB into CBs. In some embodiments, the method 500 may further comprise: calculating and adding a CRC to each of the CBs after segmenting the multi-slot TB into CBs. In some embodiments, each of the CBs may span one or more slots. In some embodiments, the number of slots which are spanned by a CB group (CBG) comprising one or more CGs segmented from the multi-slot TB is determined as follows:

$$n = ⌊ \frac{K}{N} ⌋$$

$$or$$

$$n = ⌈ \frac{K}{N} ⌉$$

where n is the number of slots which are spanned by a CBG, K is the number of slots which are spanned by the multi-slot TB, N is the number of CBGs in the multi-slot TB, └·┘ is the floor function, and ┌·┐ is the ceiling function.

In some embodiments, all the CBGs of the multi-slot TB except for the last CBG may have a same number of slots. In some embodiments, the step of determining whether segmentation of the multi-slot TB into CBs is to be performed or not may comprise: determining whether segmentation of the multi-slot TB into CBs is to be performed or not based on one or more of parameters comprising an indicator of whether the multi-slot TB is to be transmitted based on TB or based on CBG, a number of CBs in the multi-slot TB, a number of CBGs in the multi-slot TB, and a number of CBs in a CBG. In some embodiments, one or more of the parameters may be received via RRC or DCI signaling. In some embodiments, one or more of the parameters may be predefined. In some embodiments, the number of CBs in a CBG may be 1. In some embodiments, all CBGs of the multi-slot TB except for the last CBG may have the number of CBs in CBG calculated as follows:

$$⌊ \frac{number of CBs in the multislot TB}{number of CBGs in the multislot TB} ⌋$$

$$or$$

$$⌈ \frac{number of CBs in the multislot TB}{number of CBGs in the multislot TB} ⌉$$

where └·┘ is the floor function, and ┌·┐ is the ceiling function.

In some embodiments, the number of CBG in the multi-slot TB may be determined at least partially based on one or more of: a number of slots in the multi-slot TB; a size of the multi-slot TB; and a time duration from the first slot to the last slot in the multi-slot TB. In some embodiments, the method 500 may further comprise: transmitting all CBGs of the multi-slot TB in the initial transmission. In some embodiments, the method 500 may further comprise: receiving an indication of failed transmission of one or more CBGs of the multi-slot TB; and retransmitting the indicated CBGs of the multi-slot TB.

In some embodiments, the method 500 may further comprise: receiving an indication of redundancy version (RV) for the multi-slot TB via RRC or DCI signaling. In some embodiments, the method 500 may further comprise: determining a single RV for all information bits of the multi-slot TB. In some embodiments, the method 500 may further comprise: determining an independent RV for each of CBGs of the multi-slot TB. In some embodiments, the method 500 may further comprise: determining an independent RV for each of CBs of the multi-slot TB. In some embodiments, the method 500 may further comprise: keeping the multi-slot TB as it is in response to determining that the segmentation of the multi-slot TB into CBs is not to be performed. In some embodiments, the method 500 may be performed by a user equipment. In some embodiments, the multi-slot TB may be a part of a physical uplink shared channel (PUSCH).

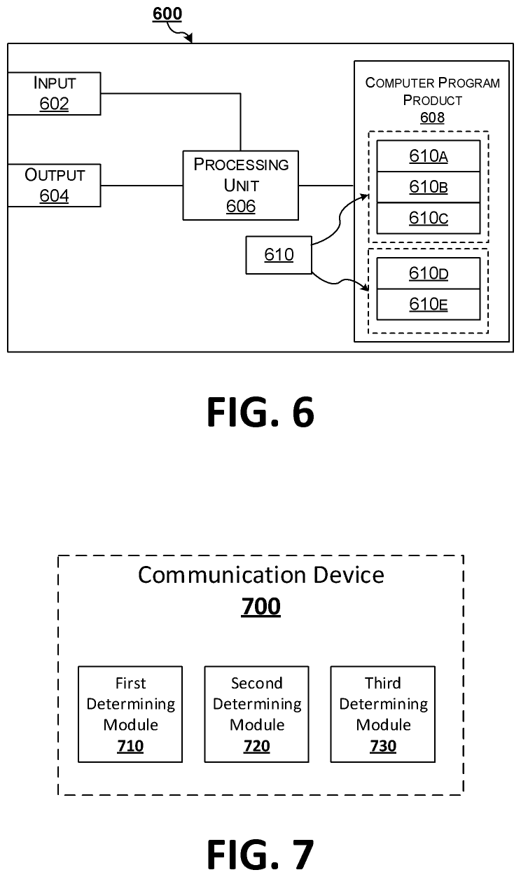

FIG. 6 schematically shows an embodiment of an arrangement 600 which may be used in a communication device (e.g., a UE or a gNB) according to an embodiment of the present disclosure. Comprised in the arrangement 600 are a processing unit 606, e.g., with a Digital Signal Processor (DSP) or a Central Processing Unit (CPU). The processing unit 606 may be a single unit or a plurality of units to perform different actions of procedures described herein. The arrangement 600 may also comprise an input unit 602 for receiving signals from other entities, and an output unit 604 for providing signal(s) to other entities. The input unit 602 and the output unit 604 may be arranged as an integrated entity or as separate entities.

Furthermore, the arrangement 600 may comprise at least one computer program product 608 in the form of a non-volatile or volatile memory, e.g., an Electrically Erasable Programmable Read-Only Memory (EEPROM), a flash memory and/or a hard drive. The computer program product 608 comprises a computer program 610, which comprises code/computer readable instructions, which when executed by the processing unit 606 in the arrangement 600 causes the arrangement 600 and/or the network elements in which it is comprised to perform the actions, e.g., of the procedure described earlier in conjunction with FIG. 1 to FIG. 5 or any other variant.

The computer program 610 may be configured as a computer program code structured in computer program modules 610A, 610B, and 610C. Hence, in an exemplifying embodiment when the arrangement 600 is used in a communication device, the code in the computer program of the arrangement 600 includes: a module 610A for determining a number of resource elements (REs) for the transmission; a module 610B for determining a number of information bits at least partially based on one or more of the determined number of REs, a modulation order for the transmission, a target coding rate for the transmission, and a number of layers for the transmission; and a module 610C for determining the size of the multi-slot TB for the transmission at least partially based on the determined number of information bits.

Further, the computer program 610 may be configured as a computer program code structured in computer program modules 610D and 610E. Hence, in an exemplifying embodiment when the arrangement 600 is used in a communication device, the code in the computer program of the arrangement 600 includes: a module 610D for determining whether segmentation of the multi-slot TB into CBs is to be performed or not at least partially based on at least one of following parameters: —whether the multi-slot TB is to be transmitted based on TB or based on CB group (CBG), —a size of the multi-slot TB, —a number of slots of the multi-slot TB, and—a time duration of the multi-slot TB; and a module 610E for segmenting the multi-slot TB into CBs in response to determining that the segmentation of the multi-slot TB into CBs is to be performed.

The computer program modules could essentially perform the actions of the flow illustrated in FIG. 1 to FIG. 5, to emulate the communication device. In other words, when the different computer program modules are executed in the processing unit 606, they may correspond to different modules in the terminal device or the network node.

Although the code means in the embodiments disclosed above in conjunction with FIG. 6 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

Correspondingly to the method 400 as described above, an exemplary communication device is provided. FIG. 7 is a block diagram of a communication device 700 according to an embodiment of the present disclosure. The communication device 700 can be e.g., a UE or a gNB. The communication device 700 may function as a UE or a gNB.

The communication device 700 can be configured to perform the method 400 as described above in connection with FIG. 4. As shown in FIG. 7, the communication device 700 may comprise a first determining module 710 configured to determine a number of resource elements (REs) for the transmission; a second determining module 720 configured to determine a number of information bits at least partially based on one or more of the determined number of REs, a modulation order for the transmission, a target coding rate for the transmission, and a number of layers for the transmission; and a third determining module 730 configured to determine the size of the multi-slot TB for the transmission at least partially based on the determined number of information bits.

The above modules 710, 720 and/or 730 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4. Further, the communication device 700 may comprise one or more further modules, each of which may perform any of the steps of the method 400 described with reference to FIG. 4.

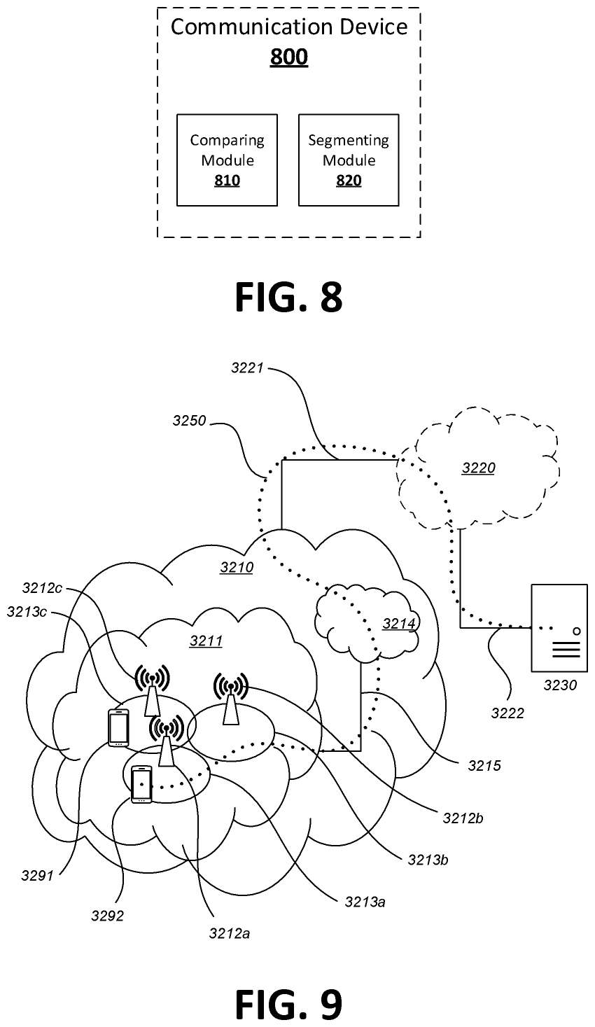

Correspondingly to the method 500 as described above, a communication device is provided. FIG. 8 is a block diagram of an exemplary communication device 800 according to an embodiment of the present disclosure. The communication device 800 can be e.g., a UE or a gNB.

The communication device 800 can be configured to perform the method 500 as described above in connection with FIG. 5. As shown in FIG. 8, the communication device 800 may comprise a determining module 810 configured to determine whether segmentation of the multi-slot TB into CBs is to be performed or not at least partially based on at least one of following parameters:—whether the multi-slot TB is to be transmitted based on TB or based on CB group (CBG), —a size of the multi-slot TB, —a number of slots of the multi-slot TB, and—a time duration of the multi-slot TB, and a segmenting module 820 configured to segment the multi-slot TB into CBs in response to determining that the segmentation of the multi-slot TB into CBs is to be performed.

The above modules 810 and/or 820 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the communication device 800 may comprise one or more further modules, each of which may perform any of the steps of the method 500 described with reference to FIG. 5.

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

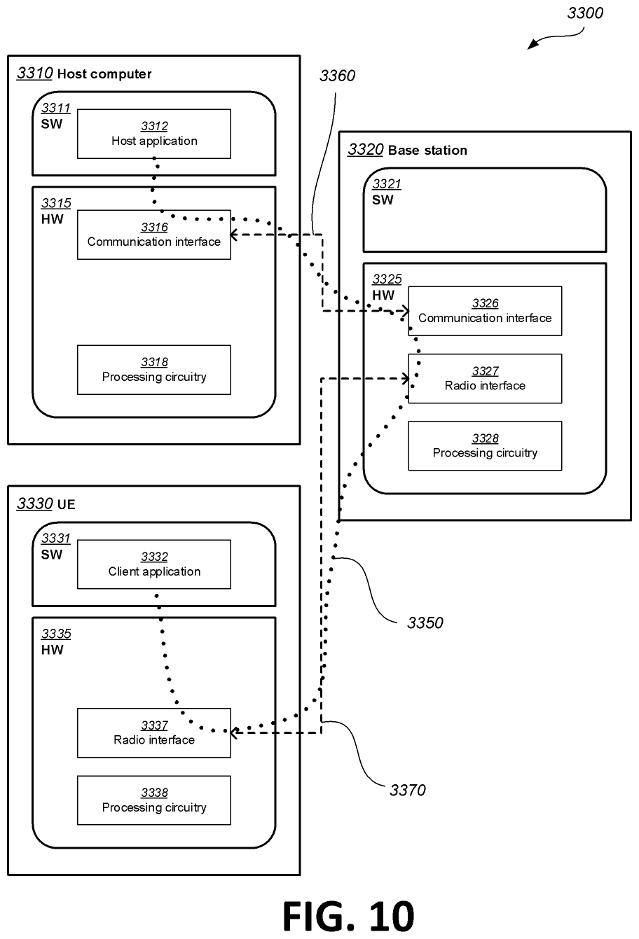

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the overall performance of uplink data transmission and thereby provide benefits such as reduced user waiting time, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

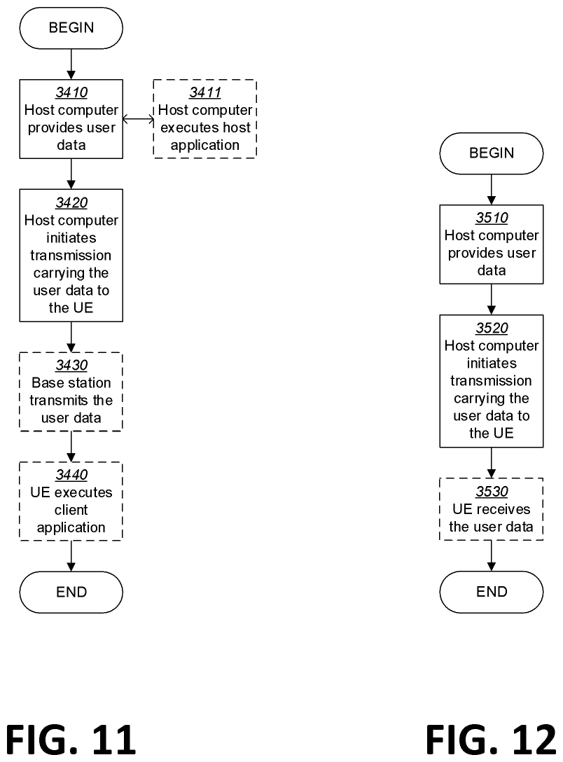

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

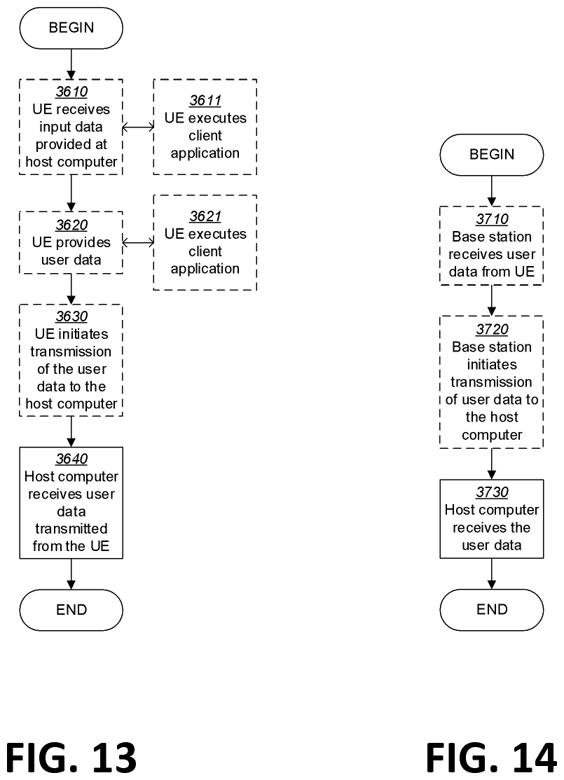

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BS | Base station |
| CB | Code Block |
| CBG | Code Block Group |
| CBGTI | Code Block Group Transmission Information |
| CG | Configured Grant |
| CRC | Cyclic Redundancy Check |
| CRM | Contention Resolution Message |
| CSI | Channel State Information |
| DCI | Downlink Control Information |
| DL | Downlink |
| DM-RS | Demodulation Reference Signal |
| eMTC | Enhanced Machine Type Communication |
| FH | Frequency Hopping |
| FR1 | Frequency Range 1 |
| FR2 | Frequency Range 2 |
| gNB | Network Node in NR |
| HARQ | Hybrid Automated Retransmission Request |
| MAC | Medium Access Control |
| Msg3 | Message 3 |
| NB-IoT | Narrow-Band Internet of Things |
| NR | New Radio |
| PDCCH | Physical Downlink Control Channel |
| PUSCH | Physical Uplink Shared Data Channel |
| PRACH | Physical Random Access Channel |
| PRB | Physical Resource Block |
| RACH | Random Access Channel |
| RE | Resource Element |
| RNTI | Radio Network Temporary Identifier |
| RSRP | Reference Signal Received Power |
| RV | Redundancy Version |
| TB | Transport Block |
| TBS | TB Size |
| TxD | Transmit Diversity |
| UE | User Equipment |
| UL | Uplink |

1. A method performed by a user equipment for determining a size of a multi-slot transport block (TB) for a multi-slot TB-based transmission, the method comprising:
determining a number of resource elements (REs) for the transmission;
determining a number of information bits at least partially based on one or more of the determined number of REs, a modulation order for the transmission, a target coding rate for the transmission, and a number of layers for the transmission; and
determining the size of the multi-slot TB for the transmission at least partially based on the determined number of information bits.

2. The method of claim 1, wherein each of the multiple slots of the multi-slot TB has an independent Demodulation Reference Signal (DM-RS) configuration.

3. The method of claim 1, wherein each of the multiple slots of the multi-slot TB has one or both of an independent number of uplink symbols and an independent number of downlink symbols.

4. The method of claim 1, wherein the multiple slots of the multi-slot TB have one or more of a same modulation and coding scheme (MCS) index, a same number of layers, and a same number of physical resource blocks (PRBs).

5. The method of claim 1, wherein the step of determining a number of resource elements (REs) for the transmission comprises:
calculating the number of REs for the transmission at least partially based on one or more of a number of PRBs allocated for the transmission, the number of slots for the transmission, and a number of REs allocated for each PRB in each of the slots for the transmission.

6. The method of claim 5, wherein the step of calculating the number of REs for the transmission comprises:
calculating the number of REs for the transmission according to following equations:
$${N}_{RE} = {\sum }_{k = 1}^{{n}_{slot}} {N}_{RE}^{k}$$
$${N}_{RE}^{k} = min ( 156 , {{N}^{′}}_{RE}^{k} ) * {n}_{PRB}$$
where, N_{RE} is the number of REs for the transmission, N_{RE}^{k} is the number of REs allocated in a slot k for the transmission, n_{PRB} is the number of PRBs allocated for the transmission, nₛₗₒₜ is the number of slots for the transmission, N′_{RE}^{k} is the number of RES allocated for each PRB in the slot k for the transmission.

7. The method of claim 5, wherein in a case where no DMRS symbol is configured in at least one slot, the step of calculating the number of REs for the transmission comprises:
calculating the number of REs for the transmission according to following equations:
$${N}_{RE} = {\sum }_{k = 1}^{{n}_{slot}} {N}_{RE}^{k}$$
$$\{ \begin{matrix}{N}_{RE}^{k} = {{N}^{′}}_{RE}^{k} * {n}_{PRB} & if no DMRS symbol is configured in slot k \\ {N}_{RE}^{k} = min ( 156 , {{N}^{′}}_{RE}^{k} ) * {n}_{PRB} & otherwise\end{matrix}$$
where, N_{RE} is the number of REs for the transmission, N_{RE}^{k} is the number of REs allocated in a slot k for the transmission, n_{PRB} is the number of PRBs allocated for the transmission, nₛₗₒₜ is the number of slots for the transmission, N′_{RE}^{k} is the number of REs allocated for each PRB in the slot k for the transmission.

8. The method of claim 5, wherein in a case where the multiple slots for the transmission have a same number of REs, the step of calculating the number of REs for the transmission comprises:
calculating the number of REs for the transmission according to the following equation:
$${N}_{RE} = min ( 156 * {n}_{slot} , {N}_{RE}^{′} ) * {n}_{PRB}$$
where, N_{RE} is the number of REs for the transmission, n_{PRB} is the number of PRBs allocated for the transmission, nₛₗₒₜ is the number of slots for the transmission, and N_{RE}′ is the number of REs in all slots per PRB.

9. The method of claim 5, wherein in a case where all the slots have a same number of REs, the step of calculating the number of REs for the transmission comprises:
calculating the number of REs for the transmission according to the following equation:
$${N}_{RE} = min ( 156 , {N}_{RE}^{″} ) * {n}_{PRB} * {n}_{slot}$$
where, N_{RE} is the number of REs for the transmission, n_{PRB} is the number of PRBs allocated for the transmission, nₛₗₒₜ is the number of slots for the transmission, and N_{RE}″ is the number of REs in each slot per PRB.

10. The method of claim 1, wherein the step of determining a number of information bits comprises:
calculating the number of information bits according to the following equation:
$${N}_{info} = {N}_{RE} * R * {Q}_{m} * v$$
where N_{info} is the number of information bits, N_{RE} is the number of REs for the transmission, Qₘ is the modulation order for the transmission, R is the target coding rate for the transmission, and ν is the number of layers for the transmission.

11. The method of claim 1, wherein the step of determining the size of the multi-slot TB for the transmission at least partially based on the determined number of information bits comprises:
comparing the determined number of information bits for the transmission with a threshold value; and
determining the size of the multi-slot TB by using a pre-determined lookup table based on the determined number of information bits in response to determining that the determined number of information bits being less than or equal to the threshold value.

12. The method of claim 11, wherein the step of determining the size of the multi-slot TB by using a pre-determined lookup table based on the determined number of information bits comprises:
determining an intermediate number of information bits based on the determined number of information bits, and
using the pre-determined lookup table to determine the size of the multi-slot TB based on the intermediate number of information bits.

13. The method of claim 11, wherein the step of determining the size of the multi-slot TB by using a pre-determined lookup table based on the determined number of information bits comprises:
quantizing intermediate number of information bits
$${N}_{info}^{′} = max ( 24 , {2}^{n} \cdot ⌊ \frac{{N}_{info}}{{2}^{n}} ⌋ ) ,$$
where n=max(3, └ log₂(N_{inf o})┘−6), and
using the pre-determined lookup table to find the closest size of the multi-slot TB that is not less than N_{info}′.

14. The method of claim 1, wherein the step of determining the size of the multi-slot TB for the transmission at least partially based on the determined number of information bits comprises:
comparing the determined number of information bits for the transmission with a threshold value; and
determining the size of the multi-slot TB according to a pre-determined equation in response to determining that the determined number of information bits being greater than the threshold value.

15. The method of claim 1, wherein the threshold value is 3824 or 8424.

16. The method of claim 1, wherein after the step of determining the size of the multi-slot TB for the transmission at least partially based on the determined number of information bits, the method further comprises:
comparing the determined size of the multi-slot TB with a maximum TB size; and
adjusting the size of the multi-slot TB to be equal to the maximum TB size in response to determining that the determined size of the multi-slot TB being greater than the maximum TB size; and
determining the size of the multi-slot TB as it is in response to determining that the determined size of the multi-slot TB being less than or equal to the maximum TB size, wherein the maximum TB size for the transmission is either predetermined or received via Radio Resource Control (RRC) or Downlink Control Information (DCI) signaling.

17. (canceled)

18. The method of claim 1, wherein after the step of determining the size of the multi-slot TB for the transmission at least partially based on the determined number of information bits, the method further comprises:
comparing the determined size of the multi-slot TB with a maximum TB size which is not pre-configured but calculated at least partially based on a maximum number of slots in a multi-slot TB; and
determining the size of the multi-slot TB as the maximum TB size in response to determining that the determined size of the multi-slot TB being greater than the maximum TB size; and
determining the size of the multi-slot TB as it is in response to determining that the determined size of the multi-slot TB being less than or equal to the maximum TB size.

19. The method of claim 18, wherein the maximum number of slots in a multi-slot TB is either predetermined or received via Radio Resource Control (RRC) or Downlink Control Information (DCI) signaling.

20. (canceled)

21. (canceled)

22. A communication device for determining a size of a multi-slot transport block (TB) for a multi-slot TB-based transmission by, the communication device comprising:
a processor;
a memory storing instructions which, when executed by the processor, cause the processor to:
determine a number of resource elements (REs) for the transmission;
determine a number of information bits at least partially based on one or more of the determined number of REs, a modulation order for the transmission, a target coding rate for the transmission, and a number of layers for the transmission; and
determine the size of the multi-slot TB for the transmission at least partially based on the determined number of information bits.

23. A method for segmenting a multi-slot transport block (TB) into code blocks (CB), the method comprising:
determining whether segmentation of the multi-slot TB into CBs is to be performed or not at least partially based on at least one of following parameters:
whether the multi-slot TB is to be transmitted based on TB or based on CB group (CBG),
a size of the multi-slot TB,
a number of slots of the multi-slot TB, and
a time duration of the multi-slot TB, and
segmenting the multi-slot TB into CBs in response to determining that the segmentation of the multi-slot TB into CBs is to be performed.

24.-46. (canceled)
